(19) United States
(12) Patent Application Publication
(10) Pub. No.: US 2015/0363552 A1
(43) Pub. Date: Dec. 17, 2015

(54) iCarenetwork

(71) Applicants: Richard M. Figallo, COLUMBUS, OH (US); James R. Hendershot, NEWARK, OH (US); Brian P. O'Riordan, ASHVILLE, OH (US)

(72) Inventors: Richard M. Figallo, COLUMBUS, OH (US); James R. Hendershot, NEWARK, OH (US); Brian P. O'Riordan, ASHVILLE, OH (US)

(21) Appl. No.: 14/714,285

(22) Filed: May 16, 2015

Related U.S. Application Data
(60) Provisional application No. 61/994,378, filed on May 16, 2014.

(51) Int. Cl. G06F 19/00

(52) U.S. Cl. CPC G06F 19/322

(57) ABSTRACT

System and method for a secure HIPPA compliant communications computing platform for real time exchanging and sharing of health and health care related information during or in between health care events along with a supporting community based application that allows members to interact with other members and nonmembers based on member set permission settings. This platform and application can also allow third party application, software and hardware development through an API (Application Program Interface)

### PROVISIONAL

Claims benefit for Application Number: 61994378 filed on May 16, 2014

### BACKGROUND

### Field of the Invention

This invention relates to a method and system for securely communicating health related information and data. Particularly, this invention meets HIPAA (Health Insurance Portability and Accountability Act) compliance of protected health information (PHI). More particularly, the invention relates to a method and systems that allows for HIPAA compliant secure communication and data storage between users within and or outside of the system on private and or public systems as determined by the owner and or generator of the data. Specifically the invention relates to a novel technique where users will be able to create an interactive community network that allows for the easy storing, sharing, notification, alerting, and exchanging of health related information and data using a plurality of data communication devices that can send and or receive data such as a PC (Personal Computer), a Television, a mobile (“portable”) monitoring device or other mobile devices. This invention is further applicable to allowing third parties to develop applications for devices and or systems to communicate data that requires a HIPAA compliant connection to the system.

### References

Patent Citations:

| Cited Patent | Filing date | Publication date | Applicant | Title |
|---|---|---|---|---|
| U.S. Pat. No. 8,850,057 | Sep. 20, 2007 | Sep. 30, 2014 | Intel Corporation | Healthcare semantic |
| | | | | interoperability |
| | | | | platform |
| U.S. Pat. No. 8,292,806 | Aug. 4, 2005 | Oct. 23, 2012 | Hitachi, Ltd. | Safety and health |
| | | | | information |
| | | | | reporting system |
| U.S. Pat. No. 6,360,254 | Mar. 30, 1999 | Mar. 19, 2002 | Amazon.Com | System and method |
| | | | Holdings, Inc | for providing secure |
| | | | | URL-based access to |
| | | | | private resources |
| U.S. Pat. No. 8,677,308 | Jan. 7, 2011 | Mar. 18, 2014 | Mastercard | Method and system |
| | | | International | for generating an |
| | | | Incorporated | API request message |
| U.S. Pat. No. 8,161,560 | Feb. 9, 2011 | Apr. 17, 2012 | Microsoft | Extensible |
| | | | Corporation | framework for |
| | | | | system security state |
| | | | | reporting and |
| | | | | remediation |
| U.S. Pat. No. 8,510,850 | Dec. 17, 2010 | Aug. 13, 2013 | Microsoft | Functionality for |
| | | | Corporation | providing |
| | | | | de-identified data |
| U.S. Pat. No. 8,370,388 | Jun. 10, 2011 | Feb. 5, 2013 | Emc Corporation | Mandatory access |
| | | | | control list for |
| | | | | managed content |
| U.S. Pat. No. 6,336,900 | Apr. 12, 1999 | Jan. 8, 2002 | Agilent | Home hub for |
| | | | Technologies, Inc | reporting patient |
| | | | | health parameters |
| U.S. Pat. No. 8,812,770 | Jul. 13, 2009 | Aug. 19, 2014 | Microsoft | Health reporting |
| | | | Corporation | from non-volatile |
| | | | | block storage device |
| | | | | to processing device |
| U.S. Pat. No. 8,230,058 | Mar. 29, 2004 | Jul. 24, 2012 | Verizon Business | Health reporting |
| | | | Global Llc | mechanism for |
| | | | | inter-network |
| | | | | gateway |
| US20110060823 | Mar. 31, 2010 | Mar. 10, 2011 | Napera Networks, | Network-assisted |
| | | | Inc | health reporting |
| | | | | activation |
| US20150007274 | Jun. 30, 2014 | Jan. 1, 2015 | International | Authentication and |
| | | | Business Machines | authorization |
| | | | Corporation | methods for cloud |
| | | | | computing platform |
| | | | | security |
| US20130254841 | Mar. 26, 2012 | Sep. 26, 2013 | Microsoft | Secure cloud |
| | | | Corporation | computing platform |
| US20120072822 | Sep. 17, 2010 | Mar. 22, 2012 | International | Data integration |
| | | | Business Machines | |
| | | | Corporation | |
| US20040030672 | Oct. 9, 2001 | Feb. 12, 2004 | Garwin Jeffrey L | Dynamic health |
| | | | | metric reporting |
| | | | | method and system |

### Publications

Persona: an online social network with user-defined privacy

Newsletter

ACM SIGCOMM Computer Communication Review—SIGCOMM ′09

Volume 39 Issue 4, October 2009

Pages 135-146

ACM New York, N.Y., USA

### SUMMARY

The method and the system of this invention centers around the innovative concept of providing an interactive health care community platform (“iCarenetwork”) that allows members (“users”) to build a secure interactive, HIPAA compliant health care community for storing, sharing, communicating and exchanging health related data within iCarenetwork and or can be extended outside of iCarenetwork. Once enrolled, members can build a community based on their data sharing and communications needs with other members within iCarenetwork and or nonmembers (“users”) outside of iCarenetwork. iCarenetwork encourages patient engagement and provider collaboration through the building of flexible real time interactive communities that can be accessed by a plurality of connected data communication devices. Data generated by users during, and in between health care encounters can be used to assist in health care coordination, health care decisions, medical emergencies and service delivery. The ease of use begins with the enrollment process by giving the option of using a public or a private authoritative sign in account. Members are empowered to build permissions based communities that will allow them to assign access rights to their data and communications.

Additionally the platform includes a developer's sandbox for a plurality of external data communication sources and computing platforms that enables customized third party applications, integration, and in-house deployments. For example; third party medical device or application capable of syncing or directly communicating data with iCarenetwork; a mobile application for user access; Healthcare Information Systems (HIS) integrations for exchanging standardized Healthcare data; de-identified data analytics; push surveys; emergency alerting.

iCarenetwork differs from current HIS in that they often require complex and costly third party solutions needed to build data communication access between providers and patients or other providers. Also they often run on disparate platforms or systems with single points of connections. iCarenetwork provides a single cross platform vendor agnostic system with multi points of connections with additionally functionalities like user defined privacy and third party development capabilities. Further HIS for service providers are traditionally designed to capture data during patient encounters meant to stay inside that service providers network with a focus on supporting the revenue cycle, not for data communication in between encounters needed for coordination of care, continuity of care or preventive interventions.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1. An example of processing a data communication event by iCarenetwork

FIG. 2. A Venn diagram example of data communication between external sources and iCarenetwork

FIG. 3a. An example of a pubic data communications network for iCarenetwork

FIG. 3b. An example of a private data communications network for iCarenetwork

FIG. 3c. An example of a hybrid data communications network for iCarenetwork

FIG. 4. An example of a portable computing device interface for access to iCarenetwork

FIG. 5. An example of a non-portable computing device interface for access to iCarenetwork

FIG. 6. An example of a an individual sign up to iCarenetwork

FIG. 7. An example of an Entity (“Organization”) sign up to iCarenetwork

FIG. 8. An example of member defined Access Control List (ACL) on iCarenetwork

FIG. 9. An example of a member defined privacy policy on iCarenetwork

FIG. 10a. An example of an individual member dashboard on iCarenetwork

FIG. 10b. An example of an Entity administrator dashboard on iCarenetwork

### DETAILED DESCRIPTION

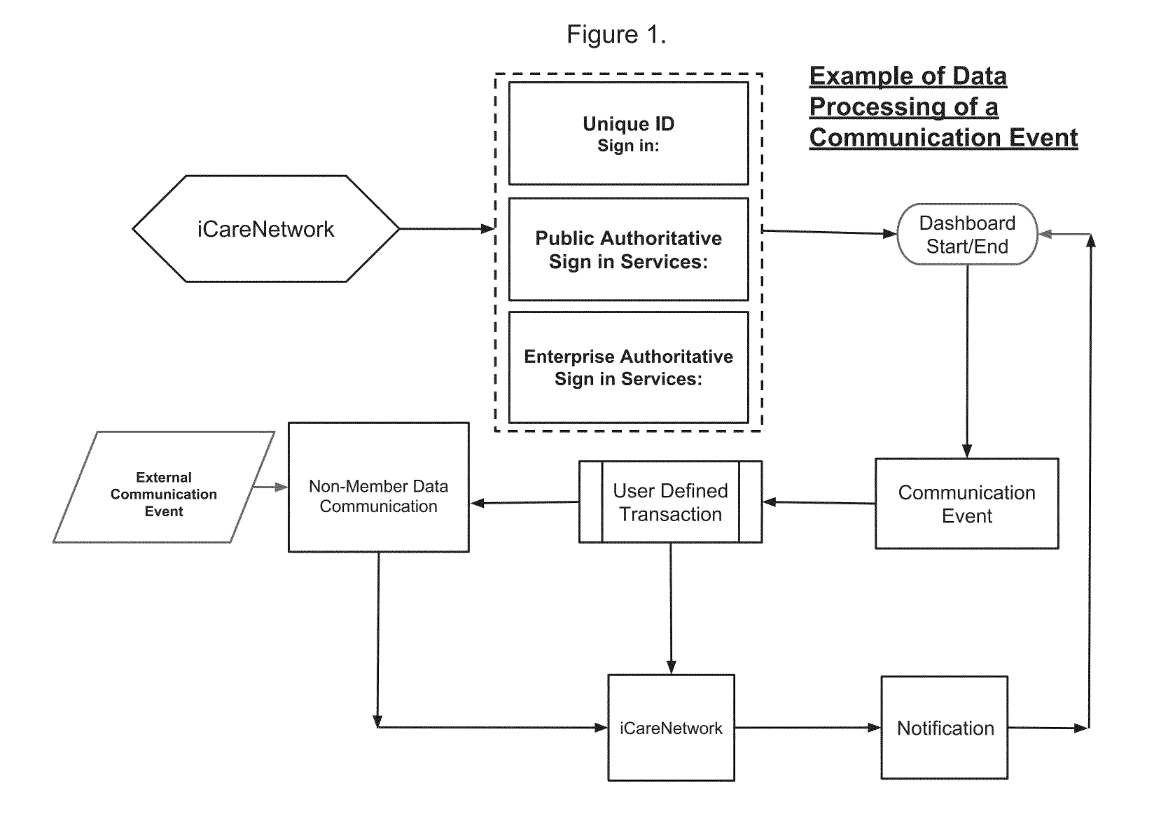

FIG. 1. An example of processing a data communication event such as a medical emergency alert, changes in health notifications, appointment updates, and updated health care information by iCarenetwork that is based on user defined settings. The event is processed within iCarenetwork and or outside of iCarenetwork to nonmembers sent and or received from other external data communication sources such as a de-identified data communication to a social network; PHI in a standardized data format to a HIS; a portable fitness/medical monitoring device; a de-identified text message from a mobile wireless network.

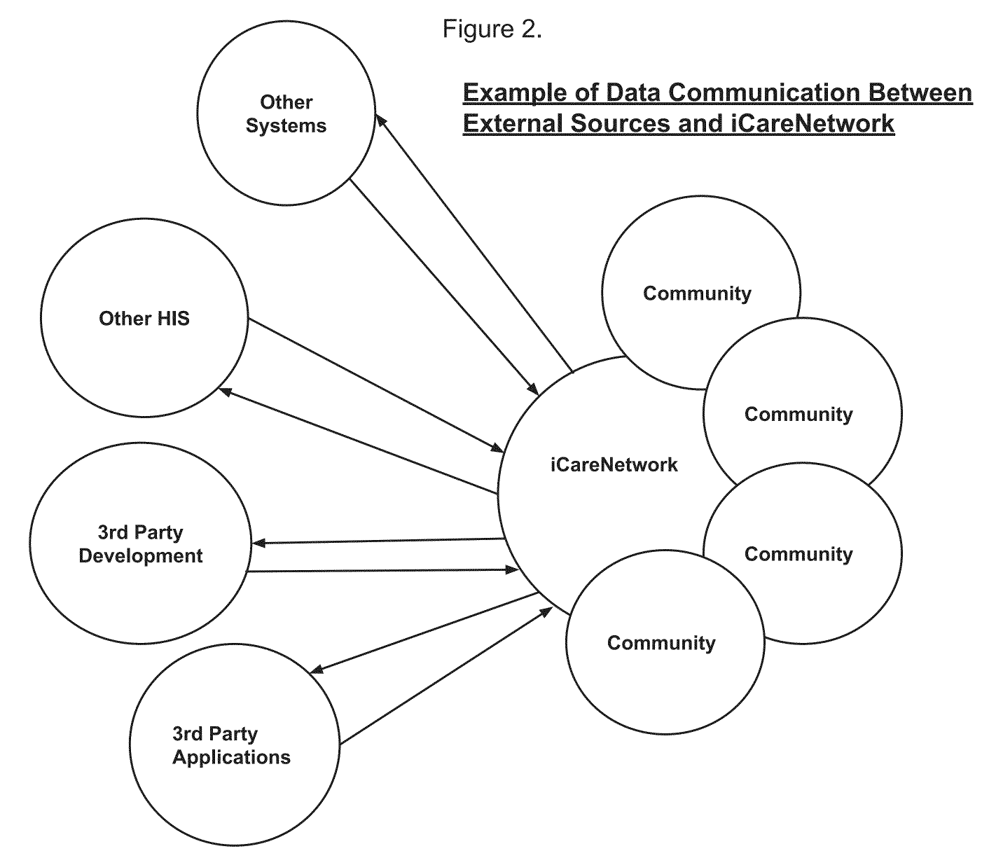

FIG. 2. A Venn diagram illustrating data communication between iCarenetwork communities and other external sources such as a Hospital HIS for integration; Enterprise Systems; third party developers for data communication with other external sources like Social Networks, web forms, other websites, fitness/medical monitoring devices by using web services.

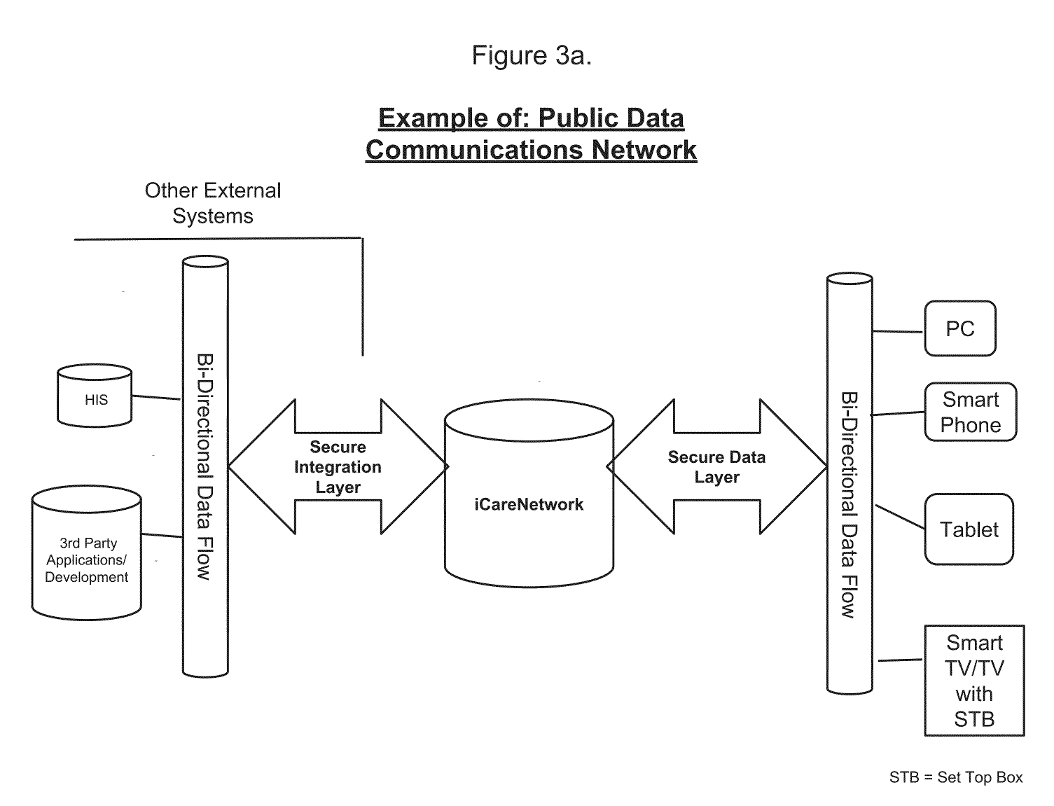

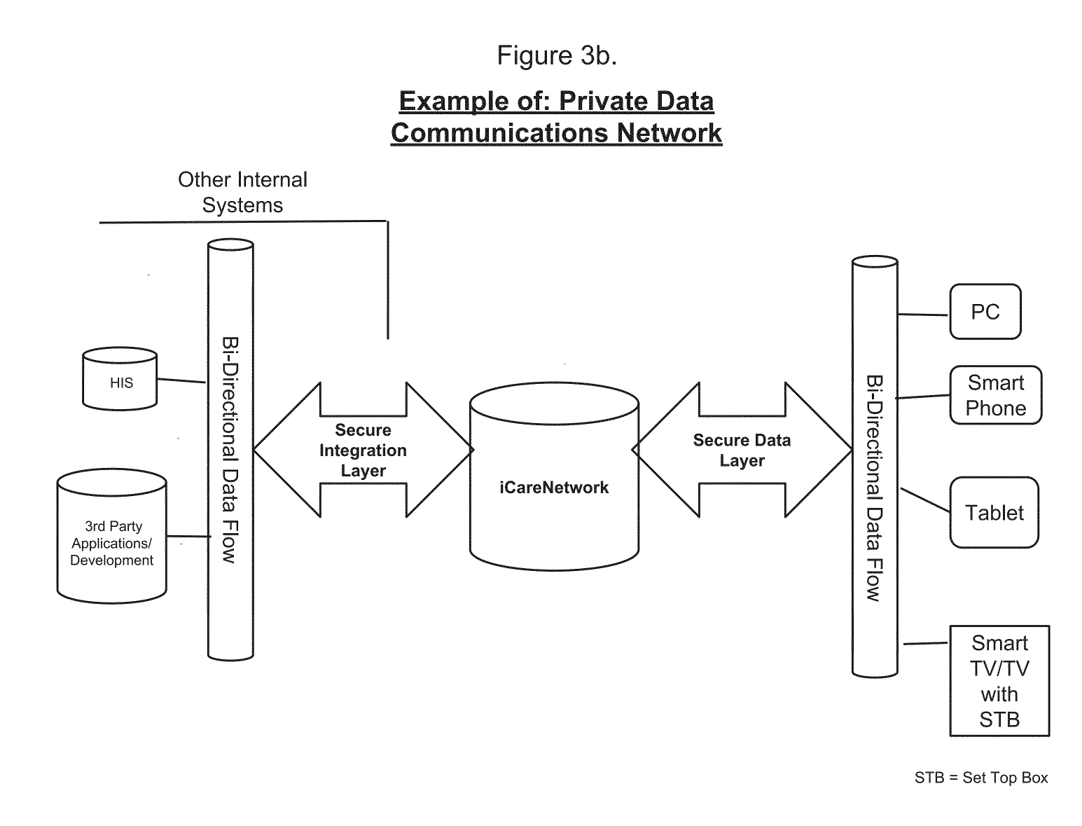

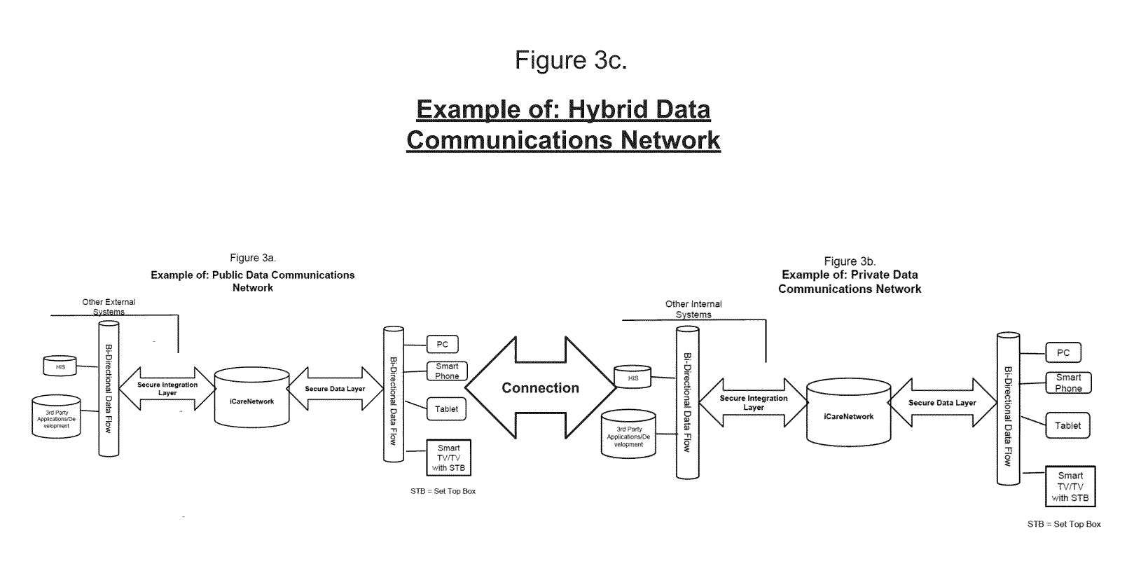

FIG. 3a. An overview of iCarenetwork on a public data communication network that allows a plurality of externally connected data communication devices and systems that can send and or receive data. An example of this would be a Platform as a Service (PaaS) on a public data center running on servers and networking hardware functioning as a Public Cloud solution.

FIG. 3b. An overview of iCarenetwork on a Private data communication network that allows a plurality of internally connected data communication devices and systems that can send and or receive data. An example of this would be a PaaS on an organization's private data center running on servers and networking hardware functioning as a Private Cloud solution.

FIG. 3c. An overview of iCarenetwork on a public and private data communication network that allows a plurality of externally and internally connected data communication devices and systems that can send and or receive data. An example of this would be a PaaS on a public and private data center running on servers and networking hardware functioning as a Hybrid Cloud solution.

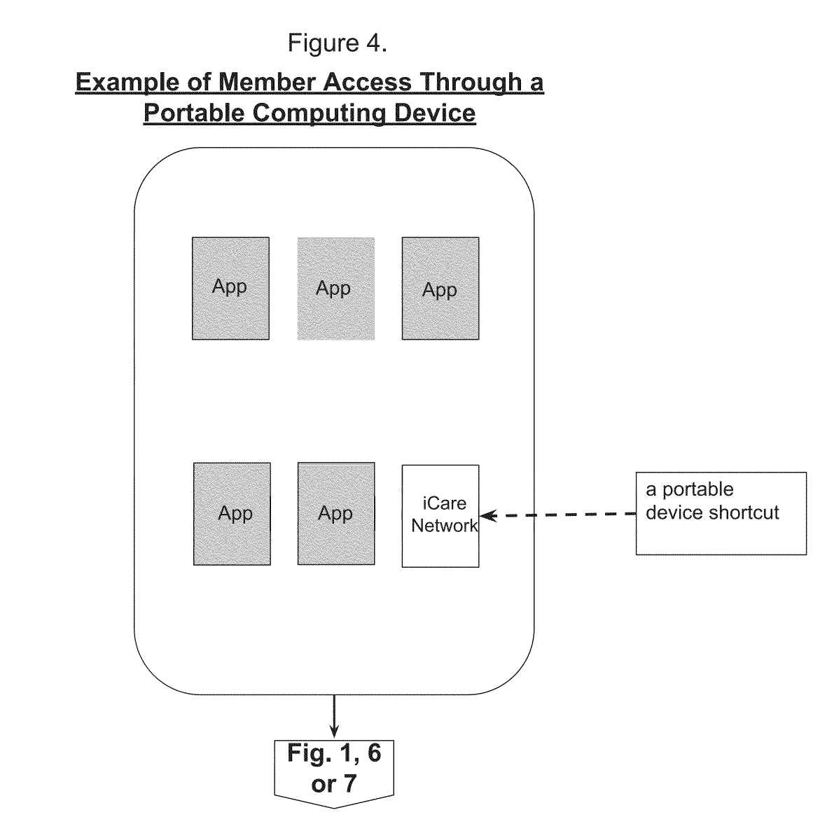

FIG. 4. Access to iCarenetwork through a connected data communication portable computing device such as a mobile phone or tablet using a browser, an application or a third party application shortcut.

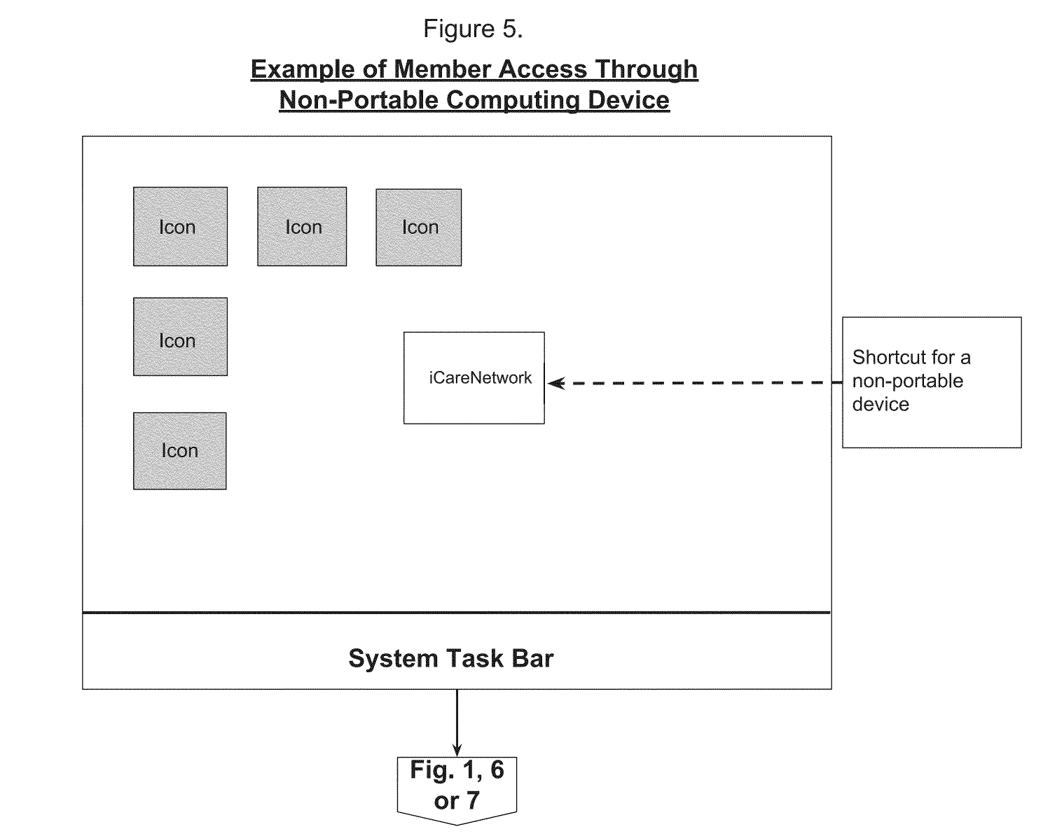

FIG. 5. Member access to iCarenetwork through a connected data communication non portable computing device such as a desktop PC using a browser, an application or a third party application shortcut.

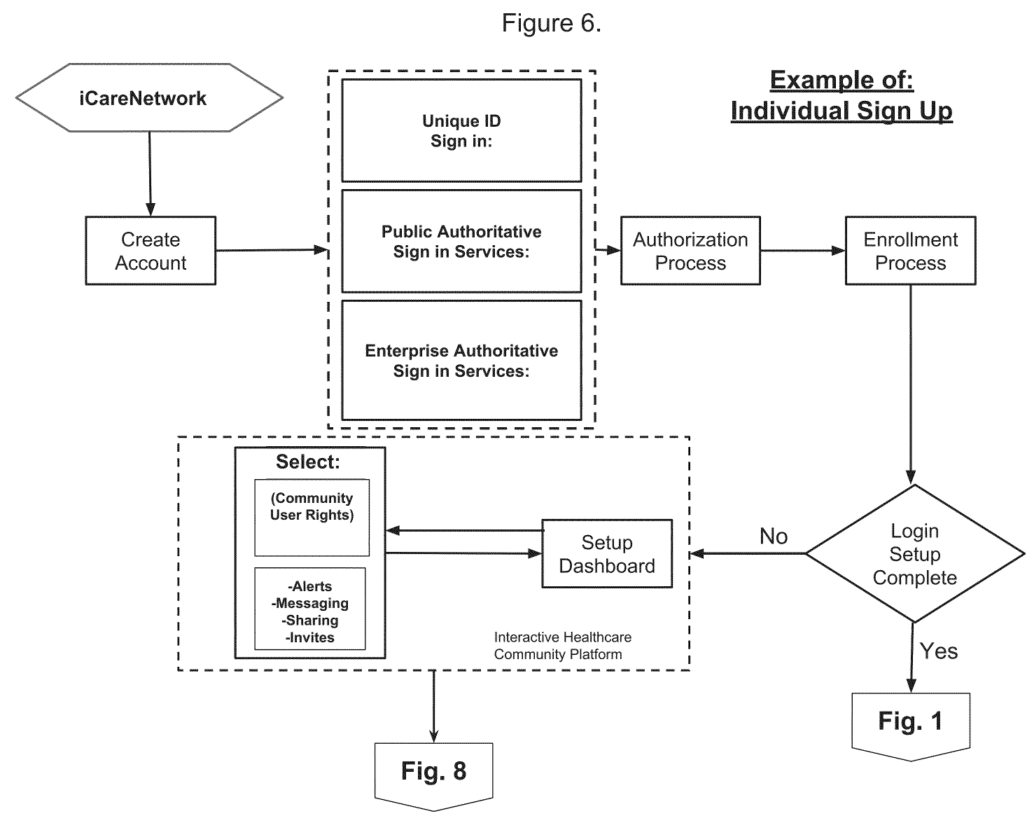

FIG. 6. A flowchart for the registration process for an individual member to iCarenetwork such as a Healthcare Consumers, Individual Health Care providers and an individual of a Healthcare Organization:
An individual member can sign up by creating a new account or by using a public authorization sign in service like Google or Facebook or a private authorization sign in service like Microsoft Active Directory or unique user ID and password
User completes an authentication process such as verifying an email address or approval from an authorized sign in service.
Once a user has been authorized they proceed to the enrollment process creating their profile with information such as demographic and basic Healthcare information like insurance, medications and allergies.
After enrollment is complete the user can sign in to their account with their credentials to begin or complete their community building process through the dashboard such as creating member and non-member communication contact list, invitations to join their network and or iCarenetwork from their contacts, Break the Glass settings (emergency contact and access process), user defined access and privacy rights or post an communication event

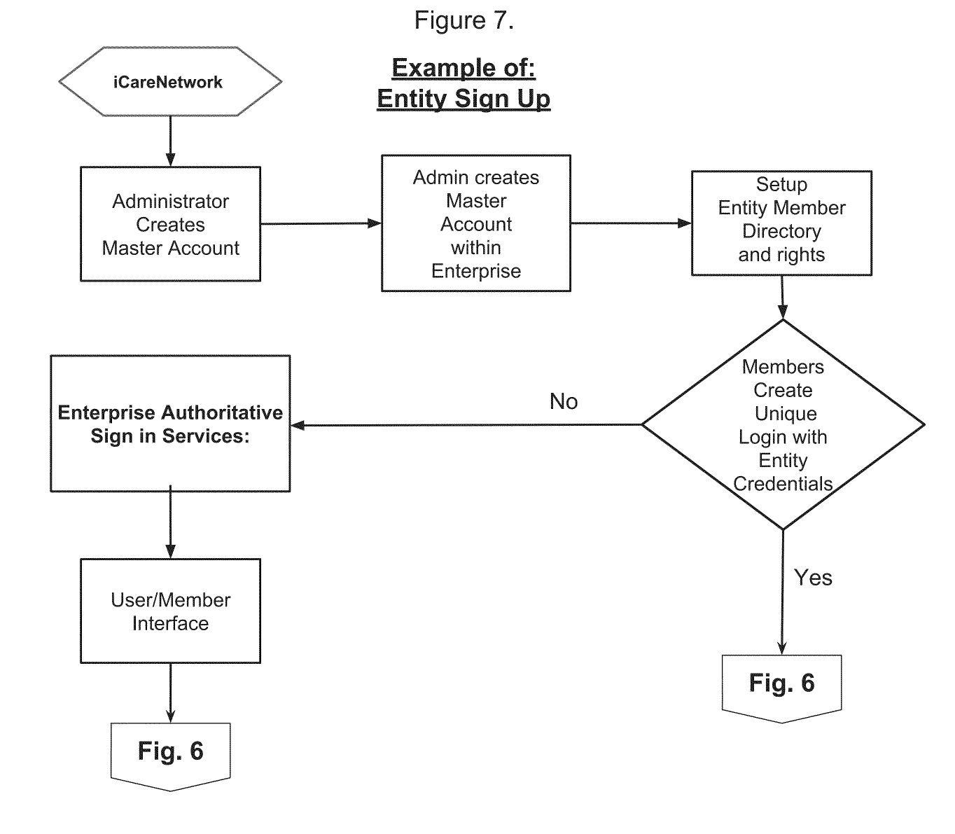

FIG. 7. A flowchart for the registration process for a multi user Entity:
An administrator for the Entity creates a master account
The administrator sets up the Entity as a public, private or hybrid Enterprise
The administrator sets up the iCarenetwork Enterprise member directory through a manual process or by using an Enterprise directory service such as Microsoft Active Directory
Enterprise members then can sign in using the administrator assigned credentials or enterprise directory credentials

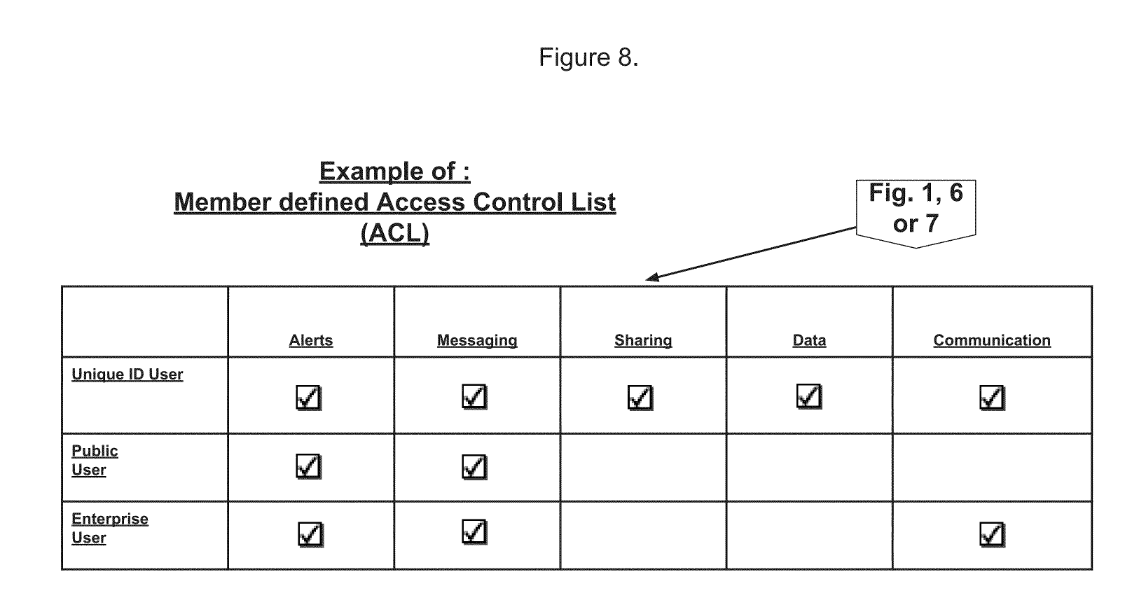

FIG. 8. Example of Member ACL (Access Control List) for access rights to other iCarenetwork members and or nonmembers and or other external data communication sources outside of iCarenetwork.

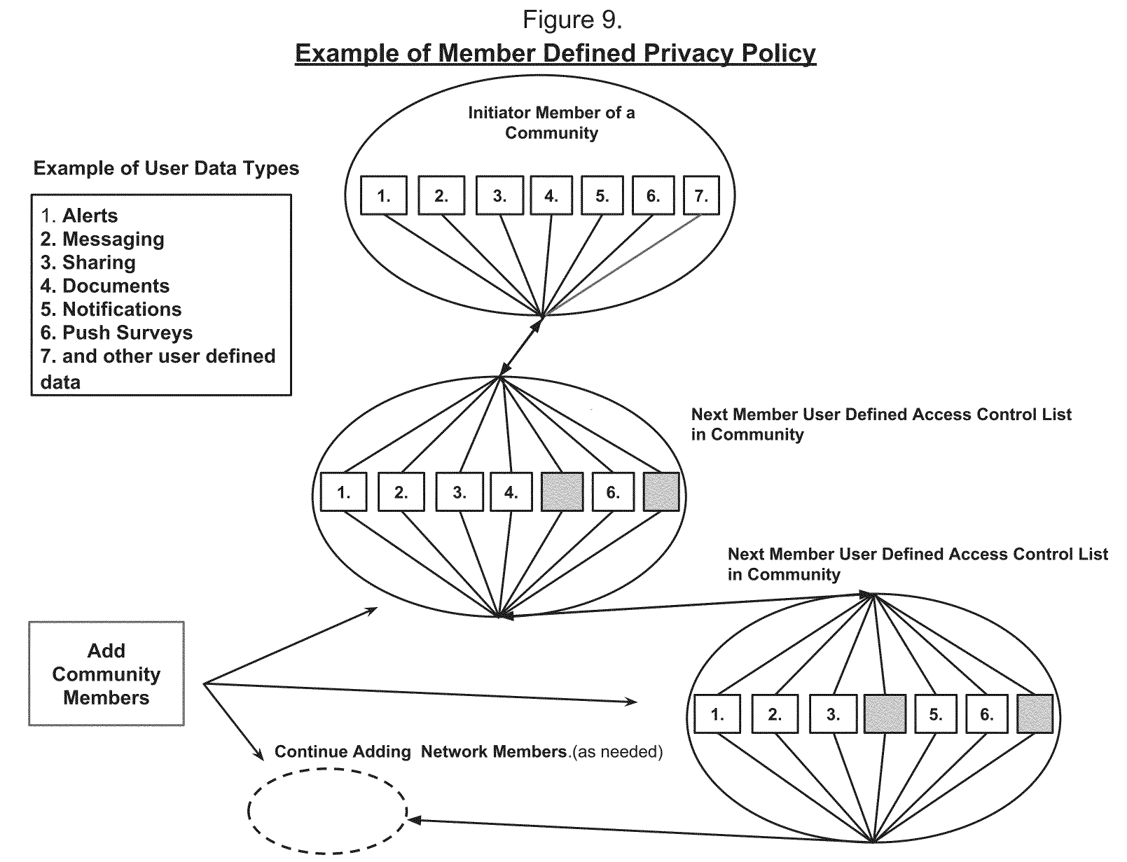

FIG. 9. Diagram example of User defined privacy policy for sharing data based on the initiating members ACL that denies, grants or limits members of their community from re-sharing their data.

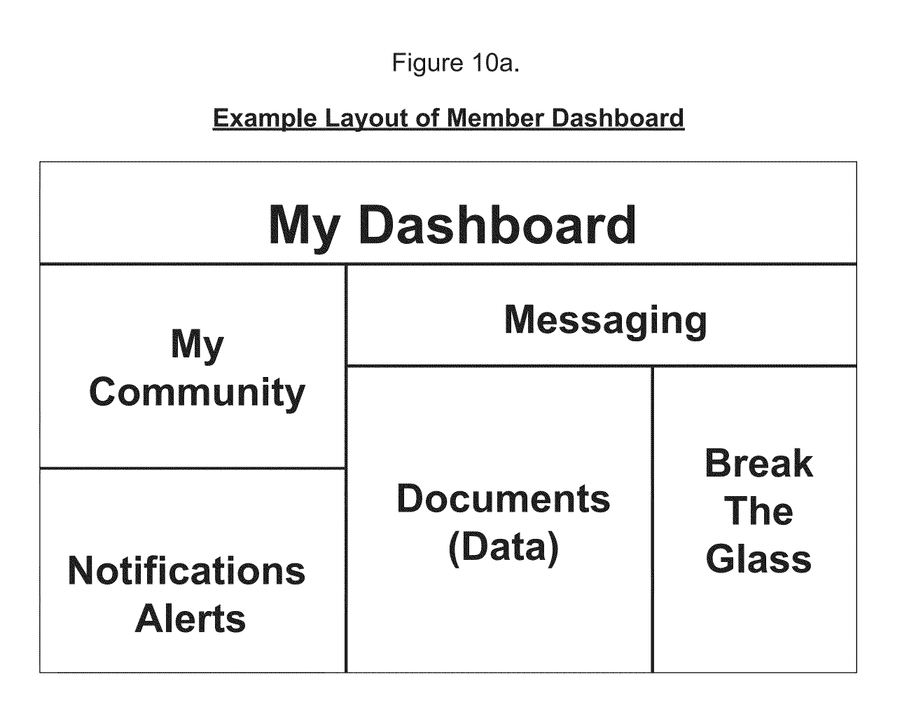

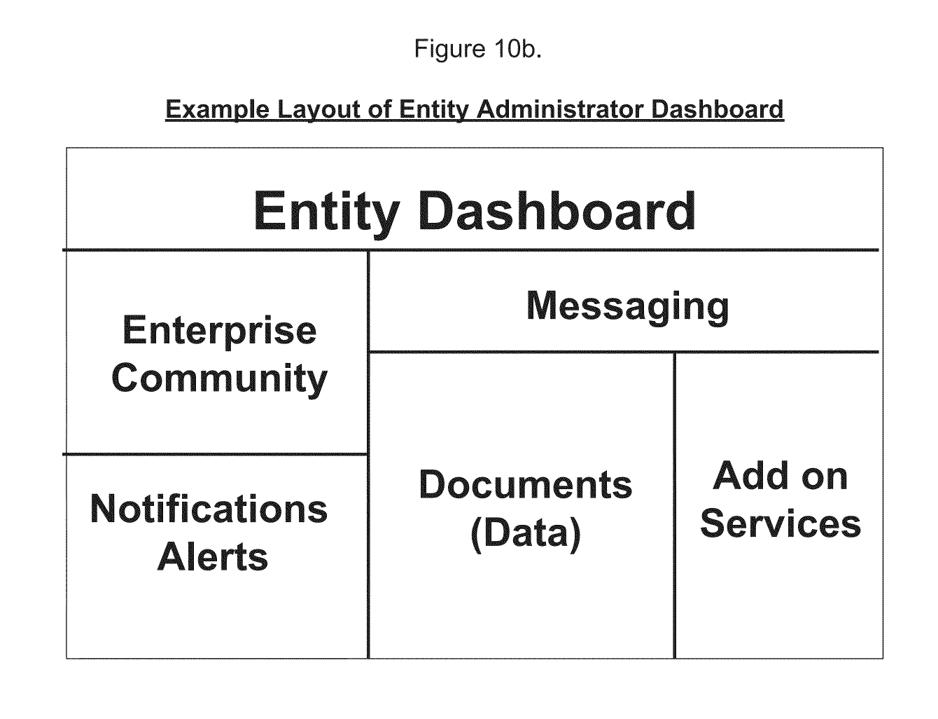

FIG. 10a. Configurable dashboard, User Interface (UI) that gives members CRUD (create, read, update, delete) access to their community building modules:
My Community is a module where the members creates their contact list of iCarenetwork members and or non-members and or other external data communication sources, ACL, and user defined privacy policy
Alerts/Notifications is a module that allow members to select individuals or groups of individuals from their contact list that they wish to alert and or notify of a communication event
Break the Glass is a module for managing a series of account access, alerts and notifications that is triggered during an emergency; for example a member has been found unconscious and has a membership identification card or bracelet that has a code or access link granting access into that members account that triggers user defined alerts and or access to Healthcare information data
Documents (Data) is a module that allows members to share, create and or upload information data and or documents
Messaging is a module where members send and or receive messages from their contacts and or external data communication sources

FIG. 10b. Configurable dashboard, User Interface (UI) that gives an Entity administrator member CRUD (create, read, update, delete) access to their Enterprise community building modules:
Enterprise Community is a module where the Enterprise administrator creates the iCarenetwork Enterprise member directory through a manual process or by using an Enterprise directory service such as Microsoft Active Directory
Alerts and or Notifications is a module that allows Enterprise administrator to select individuals or groups of individuals from their iCarenetwork Enterprise member directory for alerts and or notification of a communication event
Add on Services is a module or modules that allows the Enterprise administrator access to additional data such as utilization, communications and or analytics within their iCarenetwork community; de-identified data analytics outside of their iCarenetwork community such as other iCarenetwork members demographic and information data; create push surveys within and or outside their iCarenetwork community
Documents (Data) is a module that allows the administrator to share, create and or upload information data and or documents
Messaging is a module that allows the administrator to send and or receive messages within the iCarenetwork Enterprise member directory and or outside of the directory and or to external data communications sources through iCarenetwork

1: A method for the secure communication and data sharing of health related information through a collaborative, user access control , and HIPAA (Healthcare Insurance Portability and Accountability Act) compliant, Healthcare (iCarenetwork) computing platform:
A. and a method that creates de-identifiable alerting, data sharing, analytics and reporting, for processing, with or without the use of additional hardware, software and or middleware.
B. and a method that allows for the extraction and or transformation and or loading of data into standardized HIPAA compliant formats.
C. and a method that allows the platform to reside on or in a public, private and or hybrid data communications network.
D. and a method that allows connection through any device capable of connecting to or in a private, public, or hybrid network and can be accessed through a plurality of data communications devices by authorized users.

2: Claim 1 and a method that allows for cross computing platform development, control testing, mirroring and/or production environment for external development and or developers.

3: Claim 1 and a method that allows for an application that allows users to create an iCarenetwork account for permission based communities with access control list and member (user) defined privacy between other iCarenetwork users (members) and or non iCarenetwork users (nonmembers) for data communications, exchanging, and sharing.
